(19) United States
(12) Patent Application Publication
(10) Pub. No.: US 2008/0074459 A1
(43) Pub. Date: Mar. 27, 2008

(54) METHOD AND PRINTING SYSTEM FOR VERIFYING AND COMPENSATING SKEWNESS OF A PRINTHEAD

(76) Inventors: Hao-Wei Chang, Kao-Hsiung City (TW); Po-Chin Yang, Tai-Nan City (TW)

Correspondence Address: NORTH AMERICA INTELLECTUAL PROPERTY CORPORATION, P.O. BOX 506, MERRIFIELD, VA, 22116, US

(21) Appl. No.: 11/858,903

(22) Filed: Sep. 21, 2007

(30) Foreign Application Priority Data
Sep. 21, 2006 (TW) 095134979

(51) Int. Cl. B41J 29/393

(52) U.S. Cl. 347/19

(57) ABSTRACT

A printing system outputs an alignment pattern using a printhead where its skewness is to be calibrated. The skewness of the printhead can be detected according to the pattern match of the alignment pattern. The available number of nozzles to be used on the printhead is then determined according to the skewness of the printhead, which thereby reduces the influence of skewness of the printhead.

### BACKGROUND OF THE INVENTION

1. Field of the Invention

The present invention relates to a printing method and a printing system, and more specifically, to a method and printing system for verifying and compensating skewness of a printhead.

2. Description of the Prior Art

Bidirectional shift calibration is a general function of an ink jet printer. When a printhead moves back and forth in the printer ejecting ink drops on a printing medium, the ink drops drop down away from where it is ejected by the printhead due to the effect of moving inertia of the printhead, which causes mismatches between lines in bidirectional printing. To solve the problem, the printer prints an alignment pattern bidirectionally and the bidirectional shift is properly calibrated using the result of two segments that are best aligned with each other in the alignment pattern printed by the printer. The alignment pattern printed by the printer is illustrated in FIG. 1.

However, the ideal calibration can only be done in one situation: the chip on the printhead, which has a plurality of nozzles arranged in alignment, must be parallel to the segments of the alignment pattern so that the printhead prints reliable segments, like FIG. 1 shows. If the chip is skewed on the printhead, the bidirectional shift calibration may not assure the printer of a correct result. Please refer to FIG. 2. If the plurality of nozzles of the chip on the printhead is skewed, each straight segment in the alignment pattern will be printed askew. In such case, if segments aligned with each other have a number 0 as in FIG. 1, it will turn out to be segments with number 2 aligned with each other as in FIG. 2 due to the effect caused by the skewness of the chip on the printhead. The skewness of the printhead seriously degrades the validity of bidirectional shift calibration.

The skewness of the printhead has the effect not only on the validity of bidirectional shift calibration but also on the overall appearance of the output. The overall output leans to one side of the printing medium. A prior art technique makes an inverse directional compensation about the original printing data, outputting images that are the same as the original image. However, such prior art technique takes quite a lot of system resources. Even the structure of the program for printing may need to be reorganized.

### SUMMARY OF THE INVENTION

The present invention provides a method for verifying and compensating skewness of a printhead. The method comprises storing a skew verification pattern comprising a first segment set and a second segment set wherein the first segment set and the second segment set each comprises a plurality of numbered segments; printing an alignment pattern according to the skew verification pattern, the alignment pattern comprising a first aligning segment set and a second aligning segment set wherein the first aligning segment set and the second aligning segment set each comprises a plurality of numbered aligning segments; selecting a first aligning segment from the first aligning segment set and a second aligning segment from the second aligning segment set wherein the first aligning segment and the second aligning segment are aligned with each other and have the same number; and determining the number of nozzles to be used on the printhead according to a comparison result of the number corresponding to the selected first and second aligning segments and a skewness tolerance value.

The present invention also provides a printing system for verifying and compensating skewness of a printhead. The printing system comprises a memory for storing a skew verification pattern comprising a first segment set and a second segment set wherein the first segment set and the second segment set each comprises a plurality of numbered segments; a printhead for printing an alignment pattern according to the skew verification pattern, the alignment pattern comprising a first aligning segment set and a second aligning segment set wherein the first aligning segment set and the second aligning segment set each comprises a plurality of numbered aligning segments; a selector for selecting a first aligning segment from the first aligning segment set and a second aligning segment from the second aligning segment set wherein the first aligning segment and the second aligning segment are aligned with each other and have the same number; and a control unit for determining the number of available nozzles to be used on the printhead according to a comparison result of the number corresponding to the selected first and second aligning segments and a skewness tolerance value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an illustration of an alignment pattern for calibrating bidirectional printing shift of a prior art ink jet printer.

FIG. 2 is an illustration of an alignment pattern printed by a prior art ink jet printer having a skew printhead.

FIG. 3 is a flow chart of a method for verifying and compensating skewness of a printhead disclosed in the present invention.

FIG. 4 is an illustration of a skew verification pattern.

FIG. 5 and FIG. 6 are illustrations of an alignment pattern.

FIG. 7 is an illustration of a straight line outputted for three different conditions.

FIG. 8 is an illustration of a printing system for verifying and compensating skewness of a printhead of the present invention.

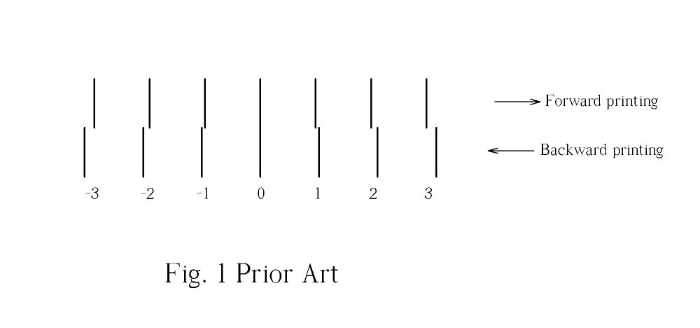

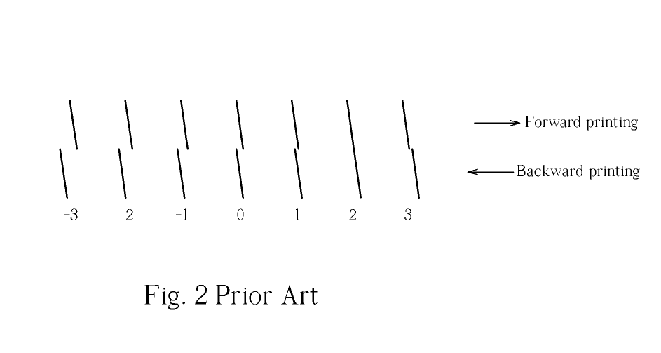

### DETAILED DESCRIPTION

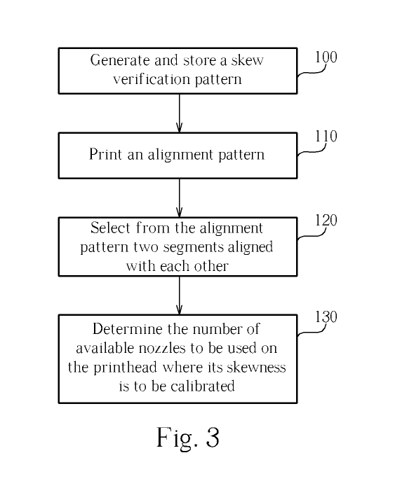

The present invention features in determining available nozzles to be used on a printhead to reduce the influence caused by the skewness of the printhead. If the chip, which has a plurality of nozzles, is not properly placed on the printhead during manufacturing, a line pattern that is originally straight will be outputted as a combination of many ripple-like small sections. If the number of available nozzles is reduced, in other words, the distance the printhead proceeds in every pass is shortened and the times of passes the printhead should go through is increased, the influence caused by the skewness of the printhead is effectively improved. FIG. 3 is a flow chart of a method for verifying and compensating skewness of a printhead. The steps are shown as the following:

Step 100: Generate and store a skew verification pattern in a printer where the skew verification pattern is composed of two segment sets wherein each segment set comprises a plurality of numbered segments;

Step 110: Output the skew verification pattern as an alignment pattern by using a printhead where its skewness is to be calibrated in the printer; the skew verification pattern is composed of two segment sets wherein each segment set comprises a plurality of numbered segments;

Step 120: Select segments from the two segment sets in the alignment pattern outputted in Step 110 aligned with each other and have the same number, which represents the degree of skewness of the printhead;

Step 130: Determine the number of available nozzles to be used on the printhead according to the number corresponding to the selected first and second aligning segments (or the degree of skewness of the printhead).

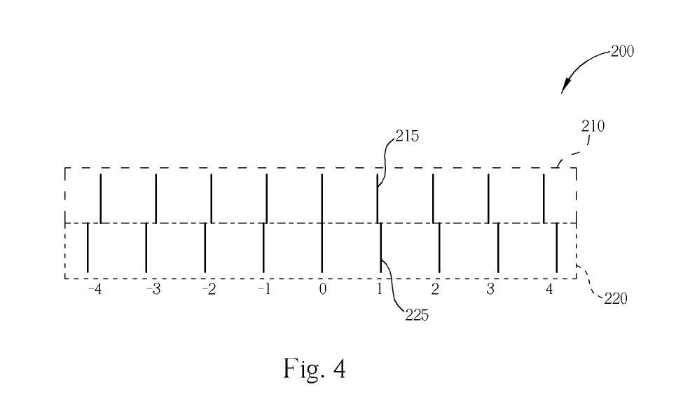

As FIG. 4 shows, a skew verification pattern 200 is generated (Step 100). The skew verification pattern 200 comprises two vertical segment sets, one in the upper part and the other in the lower part. The first segment set 210 comprises a plurality of segments 215 parallel to one another, separated by equal distance, and having equal length as the length of the printhead. The second segment set 220 comprises a plurality of segments 225 parallel to one another, separated by equal distance, and having equal length as the length of the printhead, except for the distance between any two adjacent segments 225 being different from the distance between any two adjacent segments 215, by which the printer can perform calibration according to the aligning states between the segments of the first segment set and the second segment set. Each segment of each segment set is numbered. In the exemplary embodiment in FIG. 4, the center segments are number 0 and the number increases progressively to the right and decreases progressively to the left. The segment 215 with number 0 is aligned with the segment 225 with number 0. To avoid interference of bidirectional printing, the method of the present invention establishes and stores the skew verification pattern 200 in Step 100 by printing the first segment set 210 and the second segment set 220 in single direction. The skew verification pattern 200 is outputted as shown in FIG. 4 if the skew verification pattern 200 is outputted by a non-skew printhead.

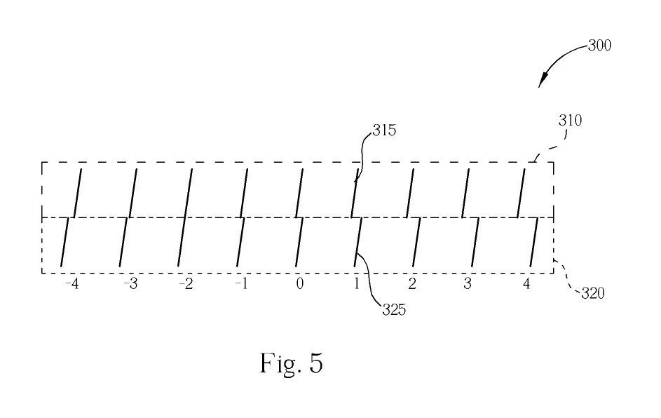

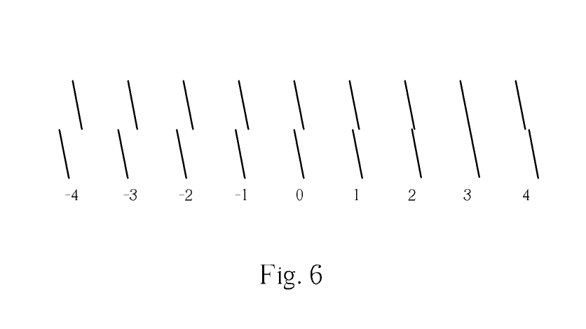

A printhead prints the skew verification pattern 200 in single direction and outputs an alignment pattern 300 in Step 110. If the printhead is skew, the output looks like the exemplary embodiment as in FIG. 5. In the alignment pattern 300 printed as in FIG. 5, the plurality of aligning segments 315, 325 of the first aligning segment set 310 and the second aligning segment set 320 are printed askew, i.e. segment 215 with number 0 and segment 225 with number 0 are aligned with each other in the skew verification pattern 200 but not aligned with each other in the outputted alignment pattern 300. Instead, segment 315 with number −2 and segment 325 with number −2 are aligned with each other in the alignment pattern 300. The number −2 is used for determining the degree of skewness of the printhead in Step 120. FIG. 6 presents another exemplary embodiment of the alignment pattern 300.

In Step 130, the method determines the number of available nozzles that eject ink drops after performing skewness calibration according to the number (or the degree of skewness of the printhead) determined in Step 120. A threshold is also set to determine the number of available nozzles, which means the skewness calibration is performed only when the degree of skewness is greater than a skew tolerance value. An exemplary embodiment is described below.

A printhead of a printer has a total number of nozzles N=300, and the skew tolerance value X of the printer (either set by a user or by the machine) is 1. When performing a skew calibration printing, the alignment pattern printed by the printhead has segments with number 2 that are aligned with each other, i.e. the number Y selected from the alignment pattern is 2. The method of the present invention introduces the following criteria in Step 130:

If Y<X, then n=N;

If Y>=X, then n=N(X/Y);

where n is the number of available nozzles to be used on the printhead after performing the skewness calibration.

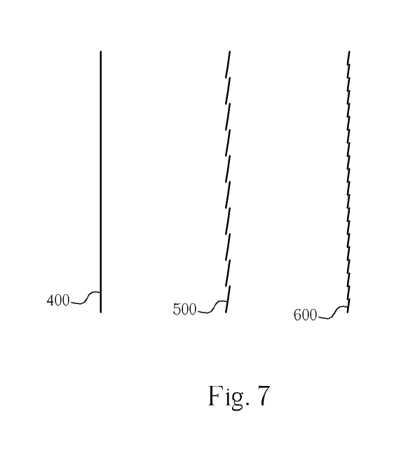

Since Y>X in the exemplary embodiment, the number of available nozzles n is 300(1/2)=150. 150 out of 300 overall nozzles of the printhead are used in the exemplary embodiment for printing, which effectively reduces the influence of skewness printed by the skew printhead. FIG. 7 illustrates a straight line outputted under three different conditions. The straight line 400 is an output printed by a non-skew printhead. The straight line 500 is an output printed by a skew printhead without performing skewness calibration. The straight line 600 is an output printed by a skew printhead with skewness calibration. Therefore, the degree of skewness can be reduced using the method of the present invention. If the printer utilizes interlacing/shingling to promote its print resolution, the method of the present invention can further adjust the number of available nozzles to be used on the printhead from the calculated result to the number of interlacings and shinglings, which ensures best print quality when performing interlacing/shingling.

Additionally, the way in which the skew verification pattern 200 and the alignment pattern 300 number the segments is a preferred exemplary embodiment of the present invention and there are various other ways of numbering the segments according to the present invention. The criteria and the skew tolerance value set in Step 130 is also a preferred exemplary embodiment according to the present invention.

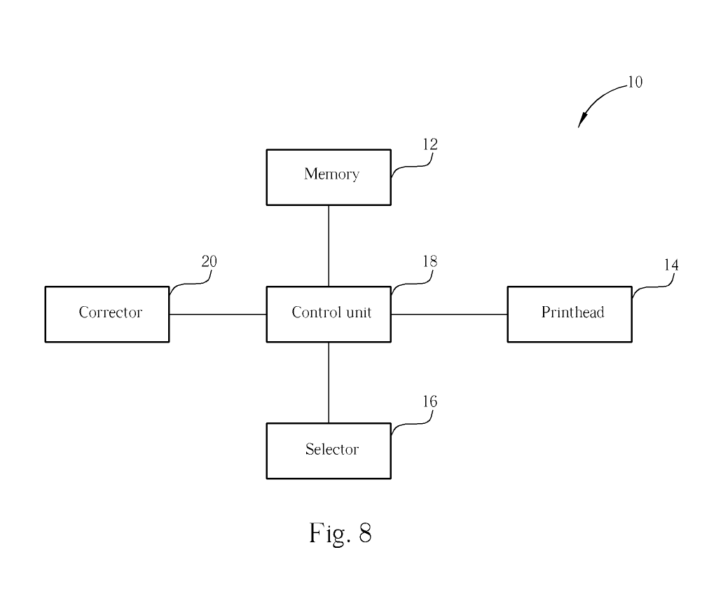

To utilize the skewness verifying and compensating method of the present invention, FIG. 8 illustrates a printing system 10 for verifying and compensating skewness of a printhead. The printing system 10 comprises a memory 12, a printhead 14, a selector 16, a control unit 18, and a corrector 20. The memory 12 is utilized for storing a skew verification pattern and the printhead is utilized for outputting an alignment pattern according to the skew verification pattern. After the printhead 14 outputs the alignment pattern 300, the selector 16 (practically it is a sensor moving with the printhead 14 or other detectors) detects the alignment pattern and obtains the information of the segments that are aligned with each other. The control unit 18 then determines the number of available nozzles to be used on the printhead 14 for printing according to the information obtained by the selector 16.

The detail of the skew verification pattern stored in the memory 12 and the alignment pattern printed by the printhead 14 are like the ones mentioned above. If the printing system 10 utilizes interlacing/shingling to promote its print resolution, when the control unit 18 determines the number of available nozzles to be used on the printhead, the corrector 20 of the printing system 10 can further adjust the number of available nozzles from the calculated result to the number of interlacings and shinglings, which ensures the printing system 10 best print quality when performing interlacing/shingling.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for verifying and compensating skewness of a printhead, comprising:
storing a skew verification pattern comprising a first segment set and a second segment set wherein the first segment set and the second segment set each comprises a plurality of numbered segments;
printing an alignment pattern according to the skew verification pattern, the alignment pattern comprising a first aligning segment set and a second aligning segment set wherein the first aligning segment set and the second aligning segment set each comprises a plurality of numbered aligning segments;
selecting a first aligning segment from the first aligning segment set and a second aligning segment from the second aligning segment set wherein the first aligning segment and the second aligning segment are aligned with each other and have the same number; and determining the number of nozzles to be used on the printhead according to a comparison result of the number corresponding to the selected first and second aligning segments and a skewness tolerance value.

2. The method of claim 1, wherein storing a skew verification pattern comprises storing the skew verification pattern comprising the first segment set having the plurality of segments with equal length as the printhead and the second segment set having the plurality of segments with equal length as the printhead.

3. The method of claim 1, wherein storing a skew verification pattern comprises storing the skew verification pattern in a manner of one-way printing.

4. The method of claim 1, wherein storing a skew verification pattern comprises storing the skew verification pattern comprising the first segment set having a first segment and the second segment set having a second segment, the first segment and the second segment aligned with each other and having the same number.

5. The method of claim 1, wherein printing an alignment pattern comprises printing the alignment pattern in a manner of one-way printing.

6. The method of claim 1, wherein determining the number of available nozzles to be used on the printhead comprises using overall nozzles of the printhead for printing when the number corresponding to the selected first and second aligning segments is smaller than the skewness tolerance value.

7. The method of claim 1, wherein determining the number of available nozzles to be used on the printhead comprises using nozzles less than the total number of nozzles of the printhead for printing when the number corresponding to the selected first and second aligning segments is not smaller than the skewness tolerance value.

8. The method of claim 7, wherein determining the number of available nozzles to be used on the printhead comprises multiplying the total number of nozzles of the printhead by a ratio of the skewness tolerance value to the number corresponding to the selected first and second aligning segments.

9. The method of claim 1, wherein determining the number of available nozzles to be used on the printhead comprises determining the number of available nozzles on the printhead by selecting a plurality of successive nozzles for printing.

10. The method of claim 1, further comprising adjusting the number of available nozzles to be used on the printhead according to the number of interlacings and shinglings when performing a printing job in interlacing/shingling.

11. A printing system for verifying and compensating skewness of a printhead, comprising:
a memory for storing a skew verification pattern comprising a first segment set and a second segment set wherein the first segment set and the second segment set each comprises a plurality of numbered segments;
a printhead for printing an alignment pattern according to the skew verification pattern, the alignment pattern comprising a first aligning segment set and a second aligning segment set wherein the first aligning segment set and the second aligning segment set each comprises a plurality of numbered aligning segments;
a selector for selecting a first aligning segment from the first aligning segment set and a second aligning segment from the second aligning segment set wherein the first aligning segment and the second aligning segment are aligned with each other and have the same number; and
a control unit for determining the number of available nozzles to be used on the printhead according to a comparison result of the number corresponding to the selected first and second aligning segments and a skewness tolerance value.

12. The printing system of claim 11, wherein the skew verification pattern comprises the first segment set having the plurality of segments with equal length as the printhead and the second segment set having the plurality of segments with equal length as the printhead.

13. The printing system of claim 11, wherein the memory is for storing the skew verification pattern in a manner of one-way printing.

14. The printing system of claim 11, wherein the skew verification pattern comprises the first segment set having a first segment and the second segment set having a second segment, and the first segment and the second segment are aligned with each other and have the same number.

15. The printing system of claim 11, wherein the printhead is for printing the alignment pattern in a manner of one-way printing.

16. The printing system of claim 11, wherein the control unit controls all nozzles of the printhead for printing when the number corresponding to the selected first and second aligning segments is smaller than the skewness tolerance value.

17. The printing system of claim 11, wherein the control unit controls nozzles less than the total number of nozzles of the printhead for printing when the number corresponding to the selected first and second aligning segments is not smaller than the skewness tolerance value.

18. The printing system of claim 17, wherein the control unit controls the number of nozzles of the printhead to be used for printing by multiplying the total number of nozzles of the printhead by a ratio of the skewness tolerance value to the number corresponding to the selected first and second segments.

19. The printing system of claim 11, wherein the control unit determines the number of available nozzles to be used on the printhead by selecting a plurality of successive nozzles for printing.

20. The printing system of claim 11, further comprising a corrector for adjusting the number of available nozzles to be used on the printhead according to the number of interlacings and shinglings when performing a printing job in interlacing/shingling.
